(19) United States
(12) Patent Application Publication
(10) Pub. No.: US 2013/0019309 A1
(43) Pub. Date: Jan. 17, 2013

(54) SYSTEMS AND METHODS FOR DETECTING MALICIOUS INSIDERS USING EVENT MODELS

(71) Applicants: William Timothy Strayer, West Newton, MA (US); Craig Partridge, East Lansing, MI (US); Alden Warren Jackson, Brookline, MA (US); Stephen Henry Polit, Belmont, MA (US)

(72) Inventors: William Timothy Strayer, West Newton, MA (US); Craig Partridge, East Lansing, MI (US); Alden Warren Jackson, Brookline, MA (US); Stephen Henry Polit, Belmont, MA (US)

(73) Assignee: RAYTHEON BBN TECHNOLOGIES CORP., Cambridge, MA (US)

(21) Appl. No.: 13/181,204

(22) Filed: Jul. 12, 2011

(51) Int. Cl. G06F 21/00; G06N 5/02

(52) U.S. Cl. 726/23

(57) ABSTRACT

Systems and methods are disclosed for determining whether a mission has occurred. The disclosed systems and methods utilize event models that represent a sequence of tasks that an entity could or must take in order to successfully complete the mission. As a specific example, an event model may represent the sequence of tasks a malicious insider may complete in order to exfiltrate sensitive information. Most event models include certain tasks that must be accomplished in order for the insider to successfully exfiltrate an organization's sensitive information. Many of the observable tasks in the attack models can be monitored using relatively little information, such as the source, time, and type of the communication. The monitored information is utilized in a traceback search through the event model for occurrences of the tasks of the event model to determine whether the mission that the event model represents occurred.

### FIELD OF THE DISCLOSURE

This application relates to detecting potential information leaks from network insiders using insider event models based on behavioral invariants.

### BACKGROUND OF THE DISCLOSURE

Many organizations are concerned by the prospect of stolen sensitive information or other forms of espionage by malicious network insiders. A malicious network insider may be either human or mechanized. For example, human insiders would generally, but necessarily, have the proper credentials to access the sensitive information, and for whatever reason, aim to exfiltrate the sensitive information to a third party. Mechanized insiders would generally be some form of malware (e.g., Trojan horse, botnet, etc.) and, by some clandestine means, have access to sensitive information and aim to exfiltrate the sensitive information to the malware's creator or some other third party. In either case, monitoring a network for repeated suspicious behavior is a useful way to detect a malicious insider. However, a malicious insider can hide effectively by varying their suspicious patterns even slightly. Furthermore, in some situations, an organization's security provisions can even aid an insider in completing their mission to exfiltrate sensitive information. For example, encrypted communications prevent network observers from viewing the communications' contents and different classification levels assigned to different classified systems can make it difficult to combine usage logs to discover suspicious behavior.

### SUMMARY OF THE DISCLOSURE

To address the deficiencies of the existing systems, this disclosure provides illustrative embodiments of methods, systems, and computer readable media storing computer executable instructions for detecting a covert mission. The disclosed methods and systems utilize event models that represent a sequence of tasks that an entity could or must take in order to successfully complete a mission. For example, missions can include the exfiltration of sensitive information, sabotage, theft, infiltration, or other espionage missions. Once a required task in an event model is detected by a network observer, detection methods and systems will traverse the event model sequentially and search for occurrences of the other tasks in the event model. If the event model sequence is found to have occurred, the mission will be considered found and network and/or security administrators will be alerted accordingly.

In some embodiments, the systems for detecting a covert mission include circuitry. The circuitry is configured to provide an event model that models the covert mission. The event model includes multiple tasks in a sequential order. The circuitry can observe an occurrence of a task in the sequence of tasks. In response to observing the occurrence of the task, the circuitry attempts to determine whether a second task in the sequence of tasks occurred before the occurrence of the initially found task. The second task precedes the initially found task in the sequence of tasks. The circuitry then determines whether the occurrence of the initially found task and the occurrence of the second task are causally related. The circuitry uses the determination regarding the causal relationship to determine whether a covert mission exists.

In some embodiments, the circuitry is further configured to issue an alarm in response to determining that there is a causal relationship between the occurrence of the initially found task and the occurrence of the second task. In some embodiments, the circuitry is configured to perform the covert mission detection using a traceback search. Generally, when performing a traceback search, the initially found task would be the last observable task in the event model and the search will be performed in sequential order through the event model. The search can be an iterative search that utilizes information about determined occurrences of tasks in the event model to determine whether a preceding task in the event model occurred.

In response to determining that there is a causal relationship between the occurrence of the initially found task and the occurrence of the second task, the circuitry searches for occurrences of additional tasks in the event model. In some embodiments, the determination that a casual relationship exists is based on a causal relationship existing between the occurrence of the initially found task, the occurrence of second task, and occurrences of other tasks in the event model. In some embodiments, a covert mission is determined to exist when a threshold regarding how many occurrences of tasks in the event model are found and how many of them are causally related. The determination of causal relationships can be based on the difference in time between occurrences of the tasks and/or the number of times a task occurs. Generally, a smaller difference in time indicates a greater likelihood that the occurrences are causally related. Whether a causal relationship exists can be determined using a multi-resolution analysis, and in particular, a state-space correlation algorithm.

In some embodiments, network probes are used to observe occurrences of the tasks. The probes can be situated to observe network communications from a gateway, router, database, repository, network client, enclave of network clients, or subnets. The network probes tag network traffic with information regarding the source address, destination address, time of communication, and/or type of communication. The type of communication can include internal flow, external flow, data entering, and/or data leaving.

Additional aspects of the disclosure relate to methods and computer readable medium for detecting a covert mission.

### BRIEF DESCRIPTION OF THE DRAWINGS

The systems and methods may be better understood from the following illustrative description with references to the following drawings in which:

FIG. 1 is a block diagram of a network that includes probes to monitor for occurrences of tasks included in an event model, according to an illustrative embodiment.

FIG. 2 is an illustrative data structure that the probes of FIG. 1 may utilize to store the monitored information, according to an illustrative embodiment.

FIG. 3 is an illustrative event model that includes a sequence of tasks, according to an illustrative embodiment.

FIG. 4 is an illustrative event model that models the tasks a malicious insider may take to exfiltrate sensitive data from a network, according to an illustrative embodiment.

FIG. 5 is a flow chart of a method for performing a traceback search process based on the event model in FIG. 4, according to an illustrative embodiment.

FIG. 6 is a generalized flow chart of a method for performing a traceback search process based on an event model, according to an illustrative embodiment.

FIG. 7 is a generalized flow chart of a method for performing a trace forward search process based on an event model, according to an illustrative embodiment.

FIG. 8 includes illustrative graphs regarding the probability that occurrences of events are causally related, according to an illustrative embodiment.

### DETAILED DESCRIPTION

To provide an overall understanding of the disclosed methods and systems, certain illustrative embodiments will now be described, including systems and methods for monitoring and mitigating information leaks from an organization's network. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

The disclosed insider detection methods and systems focus on, but are not limited to, detecting sensitive information leaks by malicious insiders. The disclosed systems and methods utilize attack models (also referred to as “event models” herein) that represent a sequence of tasks (also referred to as “steps” herein) that an entity (e.g., a human(s) or mechanism) could or must take in order to successfully complete a mission. For example, missions can include covert missions, such as, exfiltration of sensitive information, sabotage, theft, infiltration, or other espionage missions. As a specific example, an attack model may represent the sequence of tasks a malicious insider may complete in order to exfiltrate sensitive information. Most attack models include certain tasks that must be accomplished in order for the insider to successfully exfiltrate an organization's sensitive information. For example, some attack models include a required task where an insider must send the sensitive information over a particular network communications path to get to an outside destination (e.g., an adversary's server). Many of the observable tasks in the attack models can be monitored using relatively little information, such as the source, time, and type of the communication. By utilizing relatively little information, the detection methods and systems avoid imposing awkward monitoring instrumentation that can require a large amount of memory and computational power. Furthermore, the detection of a malicious insider operating within a network can be successfully completed regardless of the content and/or encryption of the insider's communications. For example, encrypting the sensitive information prior to exfiltration may not thwart the ability of disclosed insider detection methods and systems to detect the malicious insider. In fact, if encrypting data is included as a task in the attack model, such encryption may aid in detecting the attack.

Once a required task in an attack model is detected by a network observer, detection methods and systems will traverse the attack model sequentially and search for occurrences of the other tasks in the attack model. If the attack model sequence is found to have occurred, an insider attack will be considered found and network and/or security administrators will be alerted accordingly.

The use of event models is not limited to applications related to determining whether a malicious insider has exfiltrated information from a network, but can be used to determine whether other missions have been executed on a network or in any other suitable environment as long as the mission in question can be sufficiently modeled.

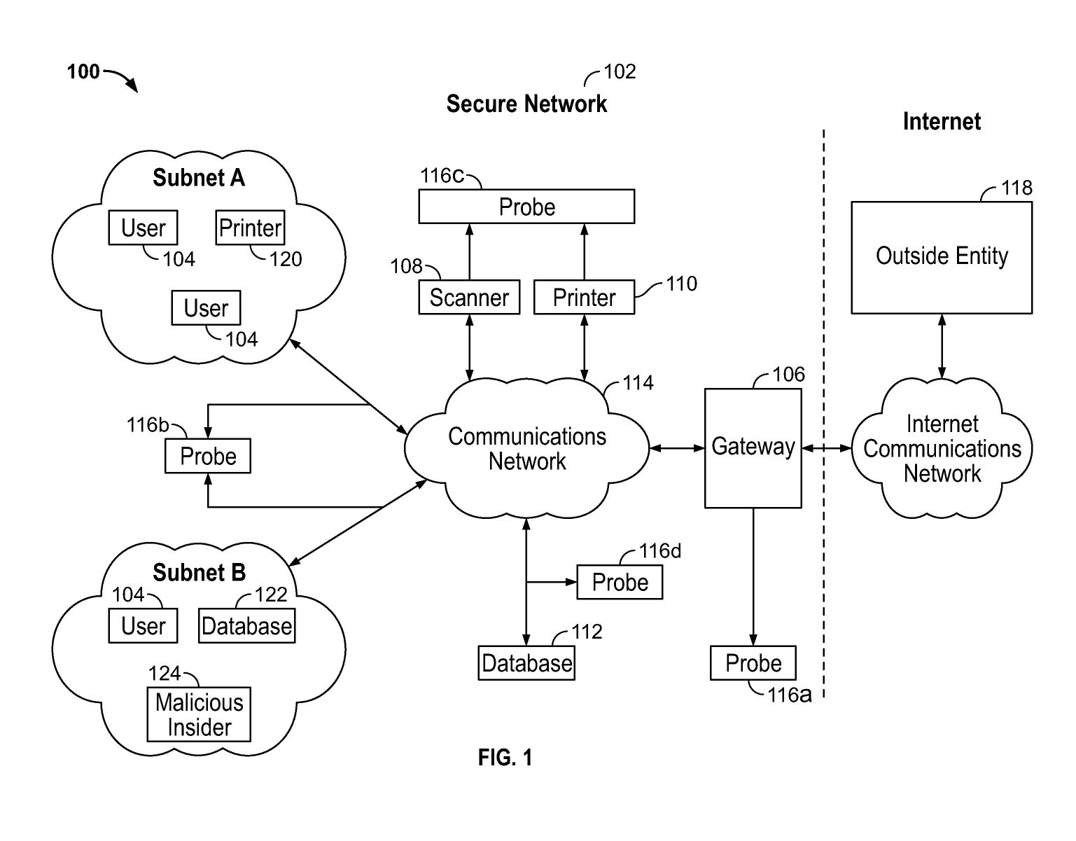

FIG. 1 is a block diagram of network 100, which includes secure network 102 and the Internet. Secure network 102 includes subnet A, subnet B, users 104, gateway 106, scanner 108, printer 110, database 112, communications network 114, and probes 116. As an illustrative embodiment, the Internet includes outside entity 118, where outside entity 118 may be any suitable server or network.

Secure network 102 implements any suitable network security mechanism, including the malicious insider detection methods and/or systems discussed herein. Secure network 102 is and/or includes any suitable network, for example, a personal area network, local area network, home area network, campus network, wide area network, global area network, organization private network, public switched telephone network, the Internet, and/or any other suitable type of network. Users 104 are users of secure network 102 and represent any suitable device in secure network 102, such as, a personal computer, mobile computing device, or a device connected into secure network 102 via virtual private network (VPN). Users 104 can communicate with any suitable element in secure network 102 and/or any suitable element in the Internet via communications network 114, which may be any suitable network or combination of networks. Users 104 can also communicate with the Internet. For example, communications going to and coming from enter and exit secure network 102, respectively, via gateway 106. For illustrative purposes, gateway 106 is an intermediary between secure network 102 and the Internet, however, any suitable network boundary device may be used to handle communications between secure network 102 and the Internet. Gateway 106 may be any suitable network device.

For illustrative purposes, secure network 102 includes two subnetworks; subnet A and subnet B. Subnet A includes some of users 104 and printer 120, and subnet B includes one of users 104, database 122, and potential malicious insider 124. The users in subnet A and subnet B can communicate with any of the other elements inside secure network 102 and the Internet via communications network 114. For illustrative purposes, potential malicious insider 124 is an actual malicious insider, however, the security mechanisms of secure network 102 would not have any information alluding to that fact until the mechanisms initiate and/or progress through the malicious insider detection methods and systems. Before the mechanisms are initiated and absent any other information, potential malicious insider 124 would likely resemble one of users 104.

Printer 110, printer 120, scanner 108, database 112, and database 122 are illustrative of network elements that may be distributed within secure network 102. Any number of elements may be included in secure network 102, and any suitable type of network element may be included in secure network 102. Printer 110, printer 120, and scanner 108 may be any suitable printer and scanner, respectively. Database 112 and database 122 may be any suitable database that, for example, stores sensitive information. All these illustrative elements may be accessible by users 104 via communications network 114. For example, potential malicious insider 124 in subnet B may download a document from database 112 to the user's local computer, and then send it to printer 120 for printing via communications network 114. As another example, potential malicious insider 124 may have in their possession a physical document with sensitive information. The potential malicious insider 124 may scan the document at scanner 108 and instruct scanner 108 to transmit the scanned document from scanner 108 to a computer that potential malicious insider 124 has access to via communications network 114. In some embodiments, security provisions may be implemented on the illustrative elements to prevent access to a respective element by a particular user or groups of users. For example, database 112 may include classified information, and as such, access to database 112 will be limited to users 104 who possess classified security clearance. Secure network 102 may include any suitable element, for example, gateways, routers, databases, repositories, network clients, enclave of network clients, subnets, user devices, etc.

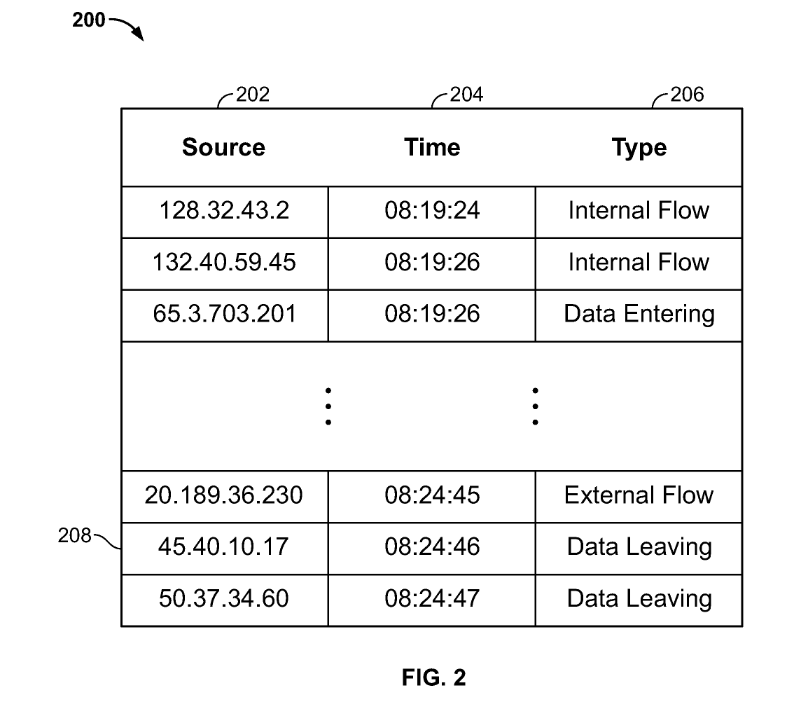

Probes 116 are distributed throughout secure network 102 and are configured to monitor network traffic that is originated by, traverses, or is received by an element or communications link to which a particular probe is connected. In some embodiments, probes 116 monitor other types of computing actions that are not network based, such as, burning data onto a recordable disc, saving information to a flash drive, encryption actions, and/or compression actions, etc. For example, probe 116a is connected to gateway 106 and monitors all or some of the network traffic that flows through gateway 106. For example, for malicious insider detection, connecting probe 116a to gateway 106 is particularly valuable because any communications leaving secure network 102, such as sensitive information exfiltrated electronically would pass through gateway 106. As a further example, probe 116b is connected to communication links between subnet A and subnet B and communications network 114. As such, probe 116b may monitor all or some of the traffic entering or exiting subnet A or subnet B. In some embodiments, probes 116 records of the information that the respective probe monitors. The type of information recorded is discussed in greater detail below with regard to FIG. 2.

There may be any suitable number of probes 116 and distributed in any suitable manner in secure network 102. The particular configuration of probes 116 in FIG. 1 is for illustrative purposes and is not meant to be limiting. Probes 116 may be implemented using any suitable software and/or hardware. In some embodiments, probes 116 may be integrated into an appropriate network element. For example, probe 116a may be integrated into gateway 106, or alternatively, probe 116a may be a standalone device directly or indirectly connected to gateway 106 using any suitable means (e.g., Ethernet cable, USB cable, etc.).

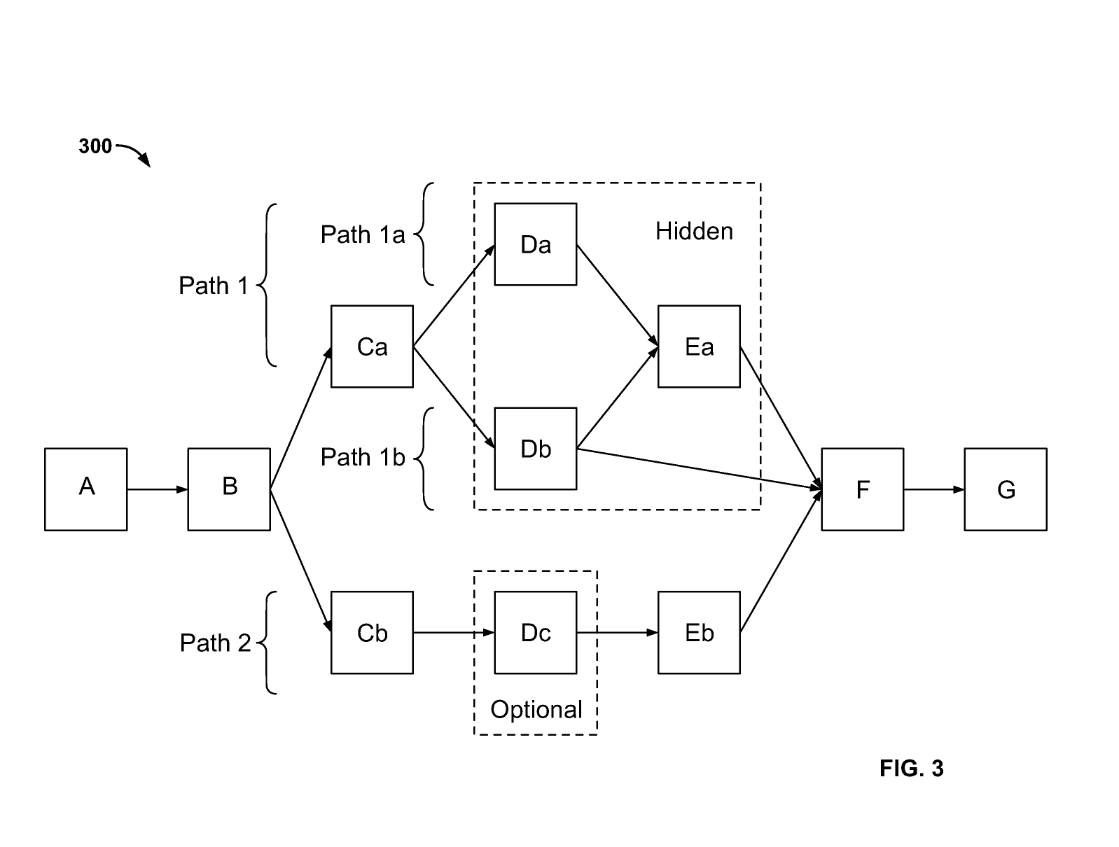

FIG. 2 depicts illustrative data structure 200 that probes 116 of FIG. 1 may utilize to store the results of the monitored information. The information stored in data structure 200 may later be used by the mission detection methods and systems to traverse a particular event model. Such embodiments, are discussed in greater detail below with regard to FIGS. 3-8. Data structure 200 may be stored at any suitable location, for example, in database 112 or database 122 of FIG. 1, or local memory within the respective probes 116, or any other suitable location. Data structure 200 may include any suitable field, but for illustrative purposes data structure 200 is depicted in FIG. 2 as having source column 202, time column 204, and type column 206. In some embodiments, data structure 200 may also include a destination column but that is not depicted here for clarity purposes.

Source column 202 includes the IP addresses of the sources of the communications that the probe monitors. For illustrative purposes, IP address 208 is included within source column 202 to represent a source address associated with a communication that a particular probe monitored, for example, probe 116a of FIG. 1. For example, IP address 208 might be associated with a computer of potential malicious insider 124 or database 112 of FIG. 1. Source column 202 may store other suitable source information, for example, MAC addresses, serial numbers, etc. Time column 204 is a time stamp for when the communication was monitored by the probe, where the time stamp can include time and date information. For example, the probe observed a communication associated with IP address 208 at the time 08:24:46.

Type column 206 stores the type of communication that is observed by the probe. Exemplary types of information are internal flow, external flow, data entering, and data leaving. Internal flow may be associated with data packet flows that are traversing the elements of secure network 102 of FIG. 1 and remain within secure network 102. For example, a data packet flows between subnet A and subnet B of FIG. 1 may be considered an internal flow. External flow may be associated with data packet flows going to or coming from outside elements or entities or networks, for example, data packet flows between subnet B and outside entity 118 of FIG. 1. Data entering may refer to a communication that enters a particular element or a communication entering secure network 102 from the Internet. For example, a communication received at gateway 106 of FIG. 1 from the Internet may be labeled as a data entering type of communication. Data leaving may refer to a communication that exits a particular element or a communication exiting secure network 102. For example, a communication received at gateway 106 of FIG. 2 from an element or subnet within secure network 102 and destined for an element on the Internet may be labeled as a data exiting type of communication. While these four data types are described herein for illustrative purposes, probes 116 of FIG. 1 and data structure 200 may monitor and store information associated with any suitable communication type. In some embodiments, a single probe can monitor all of the suitable communication types or a subset of the suitable communication types. In some embodiments, a single probe may be configured to monitor a particular communication type. For example, probe 116a of FIG. 1 may be configured to only monitor communications external flows through gateway 106. In such embodiments, multiple probes may monitor the same network point. For example, there may be additional probes connected to gateway 106 to monitor the other communication types.

Data structure 200 may be configured to store any suitable information, for example, the content of the monitored communications. However, as will be discussed below, for many event models it is not necessary to store further information to successfully detect that a malicious insider is operating in a network using an event model. As such, data structure 200 may not utilize a significant amount of network resources and can be implemented without overburdening a network compared to more cumbersome insider detection mechanisms. Furthermore, storing relatively little information per communication allows the probes to store vast numbers of communications for extended periods of time, even in busy networks.

FIG. 3 depicts illustrative event model 300 that is representative of the sequence of tasks that an entity may complete in order to fulfill a mission. For example, event model 300 may be representative of the tasks required for potential malicious insider 124 of FIG. 1 to successfully exfiltrate sensitive information from secure network 102. For illustrative purposes, task A is the initial task, for example, potential malicious insider 124 discovering that the sensitive information exists. Task G is the final task or goal of event model 300, for example, completing the goal of potential malicious insider 124 by exfiltrating data out of secure network 102 to outside entity 118.

In many situations, there are multiple possible paths that a person or mechanism can pursue to achieve a particular goal. For example, as illustrated by event model 300, there are a number of possible paths to traverse that arrive at the overall goal at task G (e.g., exfiltrating sensitive information). In particular, in traversing event model 300 from task B to task C, a person or mechanism may choose one of two possible tasks to achieve the goal at task G, i.e., from task B, the person or mechanism may pursue task Ca or pursue task Cb. Choosing one task over another task leads to a different path of tasks to attempt to accomplish the goal at task G. For example, choosing task Ca leads down path 1, while choosing task Cb leads down path 2. Different paths may also branch out into further possible paths. For example, in traversing event model 300 from task Ca to task D, a person or mechanism may choose between task Da and task Db, which lead to path 1a and path 1b, respectively.

In addition to including branching tasks, event models may also include a number of tasks that are generally hidden from observers. For example, tasks Da, Db and Ea may be hidden from probes 116 of FIG. 1. These hidden tasks may be associated with actions that do not generate network traffic, and as such, would not be monitored by network based probes 116. For illustrative purposes, the tasks not designated as hidden would be observable in some suitable fashion, for example, using network based probes 116, implementing probes 116 on individual computers to monitor local computing actions (e.g., saving data to a flash drive), or other types of security measures (e.g., physical inspections by security guards at exits of a facility). In some situations, event models may include tasks that are optional. For example, a person or mechanism trying to achieve the goal at task G would not necessarily have to complete optional task Dc to reach task Eb, but the person or mechanism could complete task Dc if they chose to do so.

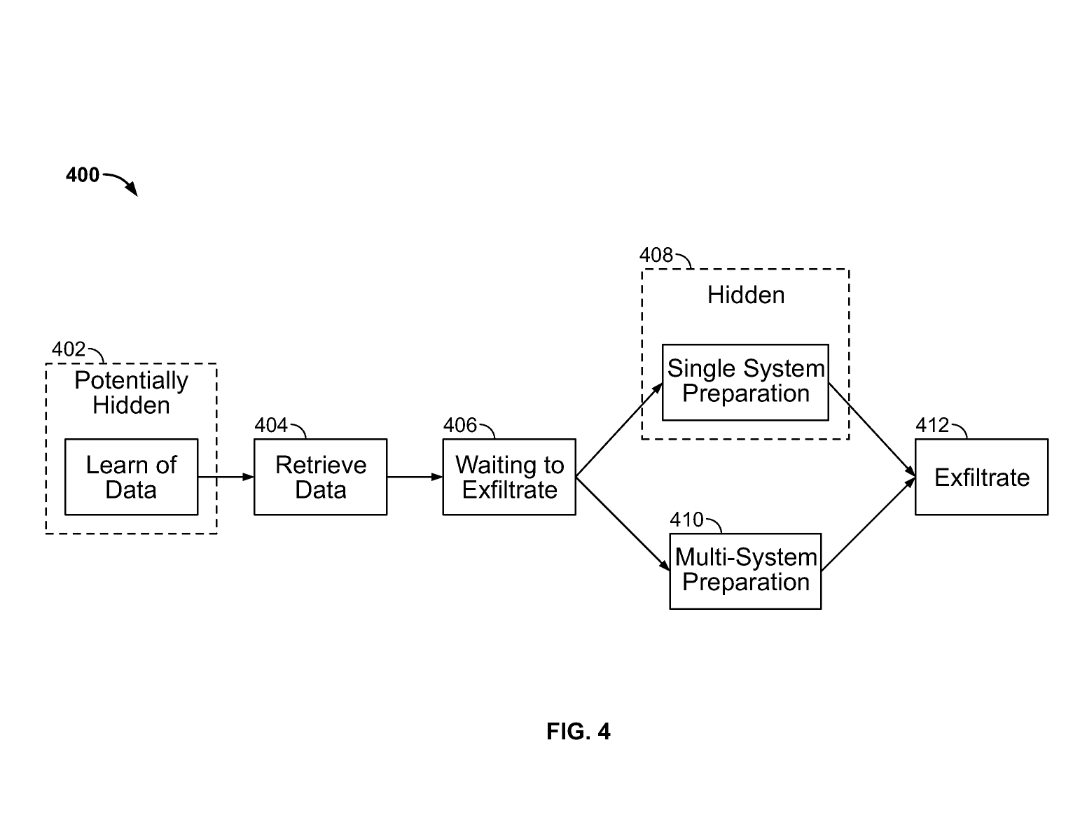

FIG. 4 shows exemplary event model 400 that models the tasks that a malicious insider (e.g., potential malicious insider 124 of FIG. 1) may take to exfiltrate sensitive data from secure network 102 of FIG. 1. The first task (i.e., task 402) in exemplary event model 400 requires that the insider first learn of the sensitive data that they would like to exfiltrate. The insider can learn about the sensitive data in any number of ways. For example, the insider might search database 112 or database 122 of FIG. 1. The act of searching the databases would not be hidden from probes 116 as there would be network communications associated with the searching that probes 116 would be able to monitor. In some situations, the insider might simply overhear some of his colleagues discussing the sensitive data, which would be hidden from probes 116. In some situations, the insider has the appropriate credentials to access the sensitive data and in some situations the insider does not have the appropriate credentials.

After learning of the sensitive data at task 402, according to event model 400, the malicious insider must next retrieve the sensitive data at task 404. In reality, the insider has a number of options as to how to retrieve the data, although the options are not illustrated in FIG. 4 to avoid overcomplicating the illustration. For example, the insider download can the data over the network from database 112 or database 122 of FIG. 1. Probes 116 would be able to monitor the communications associated with the downloading of the sensitive data because the downloading of the data would occur over the network. As another option, the insider may retrieve the data from physical files that would not necessarily be in electronic form or stored somewhere on the network. However, in this case, the insider might scan in the data to turn it into electronic form to make it easier for him to exfiltrate. In this case, the insider might utilize scanner 108 of FIG. 1 and instruct scanner 108 to forward the scanned information through secure network 102 to the insider's personal computer within subnet B. Once again, this type of communication would be visible to probes 116.

After retrieving the data of interest at task 404, the next task for the malicious insider according to event model 400 is to wait to actually exfiltrate at task 406. For example, the insider might wait a few hours before seeking to exfiltrate the data for a time when it seems safest to send data out from secure network 102 of FIG. 1 to the Internet. For example, the insider might assume that his network traffic would be less noticeable during busier times of day because data exfiltration might be more easily hidden among all the other traffic on a busy network. As a further example, the insider might assume that traffic in the middle of the night probably would be more visible to those monitoring the network traffic because there would not be much other traffic on the network during those hours.

After waiting a satisfactory amount of time to exfiltrate at task 406, the insider will next have to prepare the data for exfiltration. Here, the insider has two options as to how to prepare the data for exfiltration. The insider may choose to prepare the data using a single system at task 408 or using multiple systems at task 410. For example, the insider may choose to encrypt, package, and/or hide the sensitive data in some other fashion before sending the data out of secure network 102 using a single device, such as, the database that provided the data or the personal computer of potential malicious insider 124 where the insider locally stored the sensitive data. The single system task 408 can also include using a single system to source the data to the Internet once the data is prepared. The single system preparation option would generally be hidden from probes 116 as the single system preparation would not generate any network traffic. However, if probes 116 are configured to monitor local processes (e.g., encryption or compression actions) on the appropriate device, then probes 116 would be able to monitor the single system preparation at task 408. For illustrative purposes, task 408 is depicted as being hidden.

In contrast to the single system option at task 408, the multi-system preparation option at task 410 is generally more visible to probes 116. In the multi-system preparation option, the insider would place the sensitive data on a device different from the device where the insider retrieved the data. For example, the insider can post data retrieved from the databases to a web or FTP server to later exfiltrate the data to the Internet. Generally, moving the data between multiple devices will create network traffic that would be observable by probes 116, so task 410 would not be hidden.

The final task of exemplary event model 400 is the goal, to exfiltrate the sensitive data to an outside entity at task 412. Generally, physical media presents a substantial risk of detection for most insiders because of the security mechanisms in place at many organizations, such as searching bags for flash drives, CDs, and DVDs that might be exiting the building, so it is very likely that an insider will seek to exfiltrate data via communications network 114. For example, potential malicious insider 124 may send the data out of secure network 102 to outside entity 118 via gateway 106. This type of network communication would be visible to probes 116, for example, probe 116a that is connected to gateway 106 would observe and record the communication from potential malicious insider 124 exit gateway 106 as the communication is in route to outside entity 118.

In some embodiments, when one of probes 116 observes an occurrence of a last task in an event model, the observing probe initiates a traceback search based on the event model, where the search looks for occurrences of the previous tasks in the event model in sequential order. It will be determined that a mission associated with the event model is occurring on the network if occurrences of the previous tasks in the event model (e.g., the tasks before the last task in the event model) are found, and there is a causal relationship between the occurrences of the tasks. For example, when probe 116a detects a communication from potential malicious insider 124 exiting secure network 102 and destined for outside entity 118, probe 116a might determine that the communication might be an exfiltration event associated with task 412 of FIG. 4. Upon making that determination, probe 116a can initiate a traceback search based on the tasks in event model 400 of FIG. 4. In some embodiments, the search for occurrences through an event model might begin with the first task of the event model and traverse the event model in a forward manner (e.g., first task through last task) as opposed to starting with the last task of the event model and traversing the event model in a backward manner (e.g., last task through first task). For example, when probe 116a detects a database access communication from potential malicious insider 124 to database 112, the probe monitoring communications associated with database 112 (e.g., probe 116d) might determine that the database access communication might be associated with the learn of data event associated with task 402 of FIG. 4. Upon making that determination, probe 116d can initiate a trace forward search based on the tasks in event model 400 of FIG. 4.

While the trace forward search is possible, the traceback search is generally more efficient. The trace forward search can require that many possible partial event model paths are continuously monitored, which can require a significant amount of resources. In contrast, the traceback search limits the space of active possible event models because an event model is only examined once the event representing the final task in the event model is seen, and thus, requires less resources than the trace forward search. Furthermore, although the traceback search approach is after the fact, the traceback search is more flexible in accounting for changes in the malicious insider's acts in exfiltrating sensitive data as the malicious insider performs the exfiltration a number of times. For example, the traceback search is better than the trace forward search at detecting a malicious insider even when the insider pursues path 1 of FIG. 3 during one exfiltration event and path 2 of FIG. 3 during another exfiltration event.

In some embodiments, monitoring devices, such as probes 116 of FIG. 1, store or have access to a number of different event models of interest. As such, the monitoring devices may substantially simultaneously compare observed communications to the last tasks in each of the event models to determine whether to initiate the traceback search based on any of the event models. For example, a communication from potential malicious insider 124 to outside entity 118 resembles task 412 of event model 400, but the same communication might also resemble a task in another event model of interest, for example, an event model that models the actions of a saboteur. So, probe 116a may initiate a traceback search based on event model 400 and the event model that models the actions of a saboteur. As another example, a particular communication might resemble the last task in the other event model of interest, but not the last task in event model 400. Accordingly, monitoring device would not initiate a traceback search based on event model 400, but will initiate the traceback search based on the other event model of interest.

It many situations, probe 116a will observe a significant number of communications that, by themselves, resemble an exfiltration event associated with task 412, so it may be difficult to initiate a traceback search on based on all communications. In such situations, probe 116a may be selective as to what communications cause it to initiate a traceback search. For example, the traceback search may be initiated after monitoring a certain number of communications from the same source that resemble the last task of a particular event model. As another example, the traceback search may be initiated after monitoring communications that resemble the last task of a particular event model and are of particular size, such as 100 megabytes or more. In some embodiments, the traceback search will be initiated any time it sees communications destined for particular destinations, based off of particular IP addresses, entities, or geographic locations. For example, if a particular communication is destined for an IP address that is not previously known, not included in a safe destination list, and/or known to be associated with potentially malicious entities, then the traceback search might begin.

In some embodiments, traceback search will be initiated for substantially all communications that exit the network. In some embodiments, probes 116 initiate the traceback search. In other embodiments, a separate security system, software, device, or circuitry will initiate and handle the traceback search. In some situations, it is known that the tasks of certain models will likely or must be completed in particular parts of the network and are unlikely or cannot be completed in other parts of the network. For example, it is highly likely that the exfiltration event at task 412 will take place at or be observable at gateway 106 and unlikely to take place at scanner 108. As such, the probe connected to gateway 106 (i.e., probe 116a) will be configured to expend resources examining communications for their likelihood of being exfiltration event task 412. In contrast, probe 116c, which monitors communications associated with scanner 108 and printer 110, will not examine communications associated with scanner 108 for their likelihood of being exfiltration event task 412 because such an event is unlikely to take place at scanner 108, but can expend resources examining communications associated with scanner 108 for their likelihood of being another task within the event model.

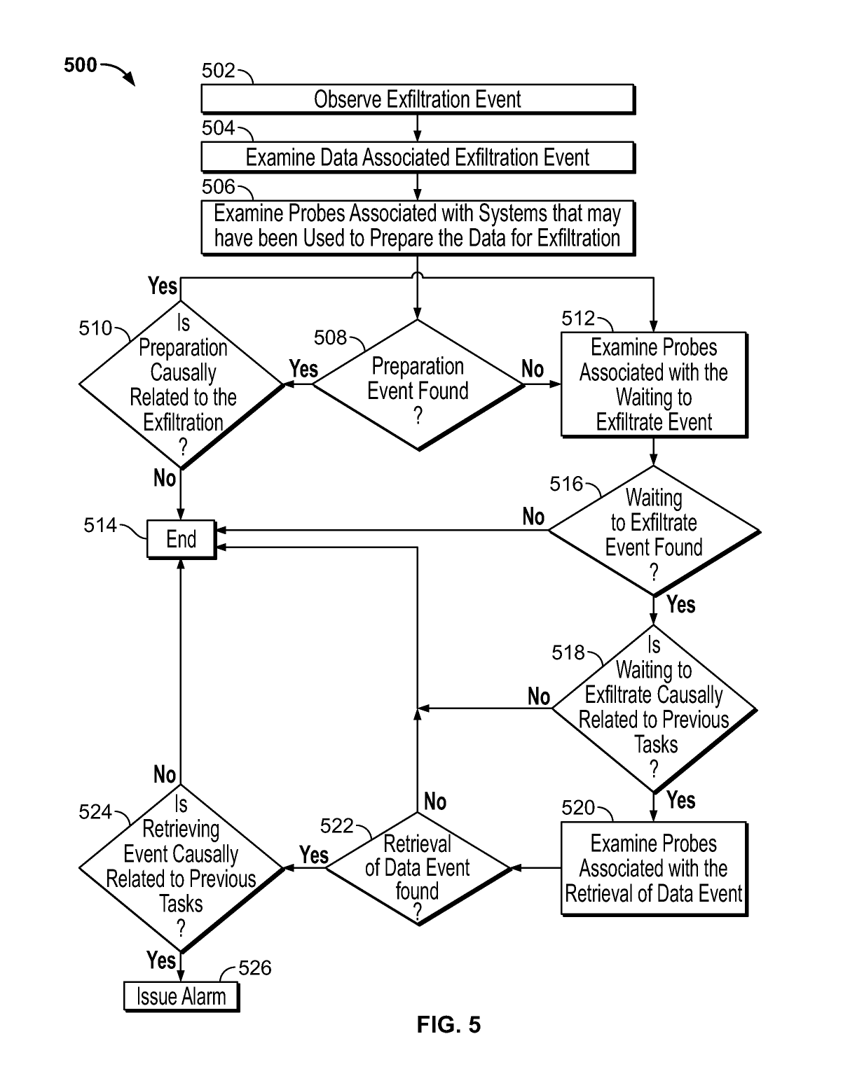

FIG. 5 shows exemplary traceback search process 500 based on event model 400 of FIG. 4. In particular, traceback search process 500 is an exemplary illustration of a traceback search for a malicious insider detection analysis based on malicious insider attack sequence illustrated by event model 400. As the last task in event model 400 is the exfiltration event associated with task 412, the traceback search process to detect a malicious insider would initiate at step 502 where an occurrence of an exfiltration event or what could possibly be an exfiltration event is observed. For example, probe 116a may have observed a possible exfiltration event communication leave secure network 102 via gateway 106. Further exemplary possible exfiltration events are discussed above with regard to task 412.

Once the exfiltration event is observed at step 502 and the traceback search is initiated, traceback search process 500 proceeds to step 504 where data associated with the observed occurrence of the possible exfiltration event is examined. As noted above with regard to FIG. 2, probes 116 will store certain information about monitored network communications such as the source of the communication, time of the communication, the type of the communication, and/or the destination of the communication. Based on this information, traceback search process 500 can determine what device within the network originated the possible exfiltration event. For example, the communication associated with the possible exfiltration event may have originated from IP address 208 in data structure 200 of FIG. 2, which for exemplary purposes is associated with database 112. Using the IP address information from data structure 200, it can be determined that database 112 originated the possible exfiltration event communication.

Once the source of the possible exfiltration event communication is determined, traceback search process 500 proceeds to step 506 where probes associated with the task just prior to the exfiltration of data are examined. In this case, the task just prior to the exfiltration of data task is the preparation of the data for exfiltration task. As illustrated by event model 400, the preparation task includes two possibilities; the single system preparation at task 408 or multi-system preparation at task 410 and as noted previously, the single system preparation at task 408 may be hidden. It is likely that the device that was the source of the possible exfiltration event communication was likely involved in the data preparation. For illustrative purposes, database 112 was the source of the possible exfiltration event communication, which can be determined by process 500 by examining the data structure associated with the probe that detected the possible exfiltration event communication. Accordingly, traceback search process 500 will examine the probe that monitors the communications associated with database 112 (e.g., probe 116d). Traceback search process 500 will examine probe 116d for records of communications that are possible associated with either single system preparation task 408 or multi-system preparation task 410. The records examined at step 506 are substantially similar to data structure 200 of FIG. 2.

Upon examining the records stored in probe 116d that are associated with database 112, traceback search process 500 proceeds to step 508 where a determination is made as to whether the previous task of the event model (i.e., the preparation event) occurred at database 112. If an occurrence of a possible preparation event is found, then process 500 proceeds to step 510. If no occurrence of a possible preparation event is found associated with database 112, then process 500 proceeds to step 512 where probes 116 are examined for occurrences of the next previous task in event model 400 (i.e., a waiting to exfiltrate event at task 406). As noted above with regard to FIG. 4, the preparation task in event model 400 could be hidden (e.g., task 408). As such, a situation where an occurrence of a possible preparation event is not found does not necessarily mean that the possible exfiltration event was not actually an exfiltration event, but instead could mean that the preparation event was hidden from the network observers (e.g., probes 116). Accordingly, when no occurrence of a possible preparation event is found, process 500 proceeds to step 512 to examine the next previous task in event model 400 (i.e., a waiting to exfiltrate event at task 406).

In practice, there may be multiple different elements within secure network 102 that could have possibly participated in the preparation task of the event model. As such, if no possible preparation event is found that is associated with the source of the exfiltration event (e.g., database 112), traceback search process 500 may examine the other elements in secure network 102 that may have participated in the preparation task before proceeding to step 512. In some embodiments, the other elements are examined simultaneously or substantially simultaneously with the examination of database 112. Additionally, as noted above, it is possible that a malicious insider may use multiple devices to handle the preparation task of event model 400 (i.e., task 410). Accordingly, process 500 may search for as many possible preparation events as possible before proceeding to the subsequent tasks in process 500.

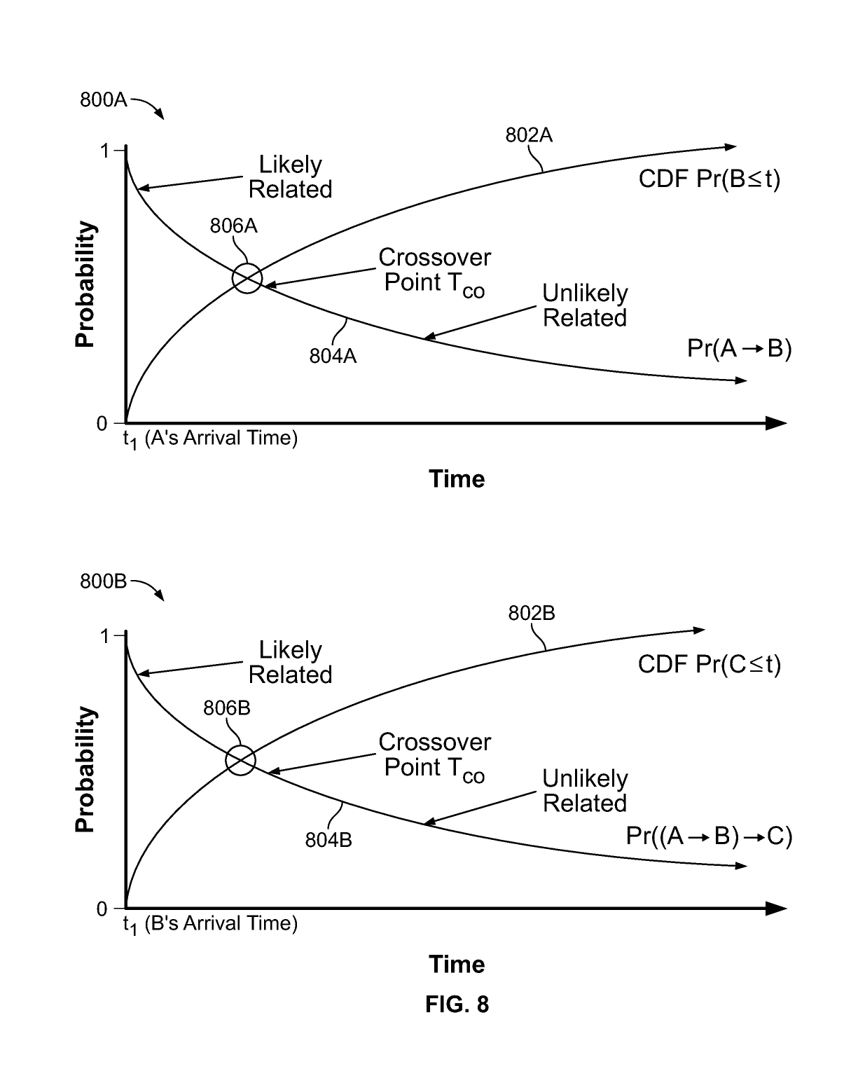

At step 510 traceback search process 500 determines whether the found occurrence of the possible preparation event is causally related to the possible exfiltration event. The occurrence of the possible preparation event is determined to be causally related to the possible exfiltration event when it is determined that the occurrence of the possible exfiltration event is likely a consequence of the occurrence of the possible preparation event. In the situation where the insider used multiple devices to handle the preparation task of event model 400 (i.e., task 410), there could be a number of occurrences of possible preparation events that are found on the network which are causally to each other and/or the possible exfiltration event. If no causal relationship is found between the occurrence(s) of the possible preparation event(s) and the possible exfiltration event, then process 500 proceeds to step 514 where the traceback search ends with a determination that the possible exfiltration event is not actually an exfiltration event or an inconclusive determination. For example, if occurrences of tasks within event model 400 are found, yet are not causally related to the possible exfiltration event, then it is likely that the possible exfiltration event was not actually an exfiltration event. If a causal relationship is found between the occurrences of the possible preparation and possible exfiltration events, the process 500 proceeds to step 512 where probes 116 are examined for occurrences of the next previous task in event model 400 (i.e., a waiting to exfiltrate event at task 406). In some embodiments, events are determined to be causally related when the confidence level of the causal relationship meets or exceeds a threshold. For example, the confidence level can be related to the probability of the causal relationship between two events. In some embodiments, the causal relationship is determined for the multiple tasks in an event path. For example, it can be determined whether there is a causal relationship between occurrences of all the tasks in a path in an event model, which can be based on an accumulated causal relationship confidence level for the entire path. This accumulated confidence level is compared to the confidence level threshold to determine whether there is a causal relationship between events for the entire path. The determination of causal relationships between tasks in an event model is discussed in greater detail below with regard to FIG. 8.

At step 512 probes that are associated with the waiting to exfiltrate event at task 406 of event model 400 are examined. If process 500 arrives at step 512 from step 508 (i.e., when no occurrence of a preparation event is found), then there is no direct information about what elements in secure network 102 may have been used to complete the waiting to exfiltrate event. For example, no source information associated with possible elements would be available via data structure 200. As such, traceback search process 500 may have to examine many or all of the possible elements within secure network 102 that may have been used to complete the waiting to exfiltrate event. Alternatively, if process 500 arrives at step 512 from step 510 (i.e., when occurrence of a preparation event is found and is causally related to the exfiltration event), then process 500 may utilize the source information in data structure 200 to narrow the possible elements that may have been used to complete the waiting to exfiltrate event. For example, if it is known that database 112 was used to prepare the data for exfiltration, process 500 can examine probe 116d that is associated with database 112 to determine where the data that was prepared at database 112 came from. After examining the probes associated with the waiting to exfiltrate event, process 500 proceeds to step 516.

At step 516 it is determined whether an occurrence of a waiting to exfiltrate event is found. If no occurrence is found, then process 500 proceeds to step 514 where the traceback search ends with a determination that the possible exfiltration event is not actually an exfiltration event or an inconclusive determination. For example, if no waiting to exfiltrate occurrence is found, then it is likely that the possible exfiltration event was not actually an exfiltration event, especially because, according to event model 400, the waiting to exfiltrate task 406 is a required and observable task.

If a waiting to exfiltrate occurrence is found, then process 500 proceeds to step 518 to determine whether a causal relationship exists between the waiting to exfiltrate occurrence and the other occurrences. For example, process 500 can determine whether there is a causal relationship between (1) the waiting to exfiltrate occurrence and the preparing to exfiltrate occurrence, (2) the waiting to exfiltrate occurrence and the exfiltrating occurrence, and/or (3) the waiting to exfiltrate occurrence and the combination of the preparation and exfiltrating occurrences. If no causal relationship is found between the occurrence(s) of the possible event(s), then process 500 proceeds to step 514 where the traceback search ends with a determination that the possible exfiltration event is not actually an exfiltration event or an inconclusive determination. As discussed above, when no causal relationship is determined, it is likely that the possible exfiltration event was not actually an exfiltration event. The determination of causal relationships between tasks in an event model is discussed in greater detail below with regard to FIG. 8.

If a causal relationship is found, process 500 continues on to step 520 to examine probes associated with the next previous in event model 400 (i.e., the retrieval of data event at task 404). At step 520 probes associated with the retrieval of data event are examined in a similar manner as discussed above with regard to step 506 and step 512. After examining the probes associated with the retrieval of data event, process 500 proceeds to step 522.

At step 522 it is determined whether an occurrence of a retrieval of data event is found. If no occurrence is found, then process 500 proceeds to step 514 where the traceback search ends with a determination that the possible exfiltration event is not actually an exfiltration event or an inconclusive determination. For example, if no retrieval of data occurrence is found, then it is likely that the possible exfiltration event was not actually an exfiltration event, especially because, according to event model 400, the retrieve data task 404 is a required and observable task.

If a retrieval of data occurrence is found, then process 500 proceeds to step 524 to determine whether a causal relationship exists between the retrieval of data occurrence and the other occurrences. This causal relationship determination may be substantially similar to the causal relationship determination made at step 518, except this determination will include the addition of the retrieval of data occurrence in the causal relationship analysis. If no causal relationship is found between the occurrence(s) of the possible event(s), then process 500 proceeds to step 514 where the traceback search ends with a determination that the possible exfiltration event is not actually an exfiltration event or an inconclusive determination. As discussed above, when no causal relationship is determined, it is likely that the possible exfiltration event was not actually an exfiltration event. The determination of causal relationships between tasks in an event model is discussed in greater detail below with regard to FIG. 8.

If a causal relationship is determined, then process 500 can determine that the occurrence of the possible exfiltration event was indeed an actual exfiltration event because occurrences of all the required and observable tasks in event model 400 were found and determined to be causally related. As noted above, the initial task of learning of the data in the event model (i.e., task 402) may be hidden and may not be possible to discover. As such, it may not be necessary to find an occurrence of task 402 to make the final decision that the possible exfiltration event was indeed an actual exfiltration event. Accordingly, process 500 can proceed to step 526 to issue an alarm that indicates that a covert mission may be taking place on the network, in this case, an exfiltration mission. The alarm may be any suitable alarm. In some embodiments, system or security managers/operators are notified that there is a suspected covert mission taking place on the network. In some embodiments, the alarm is accompanied with source information. For example, the earliest task in the event model (e.g., the last task evaluated in the traceback search) may be closely related to the malicious insider. As such, the source information maintained by probes 116 may give an indication as to who or what initiated the exfiltration mission. Appropriate security measures may be taken when the initiator of the exfiltration mission is determined.

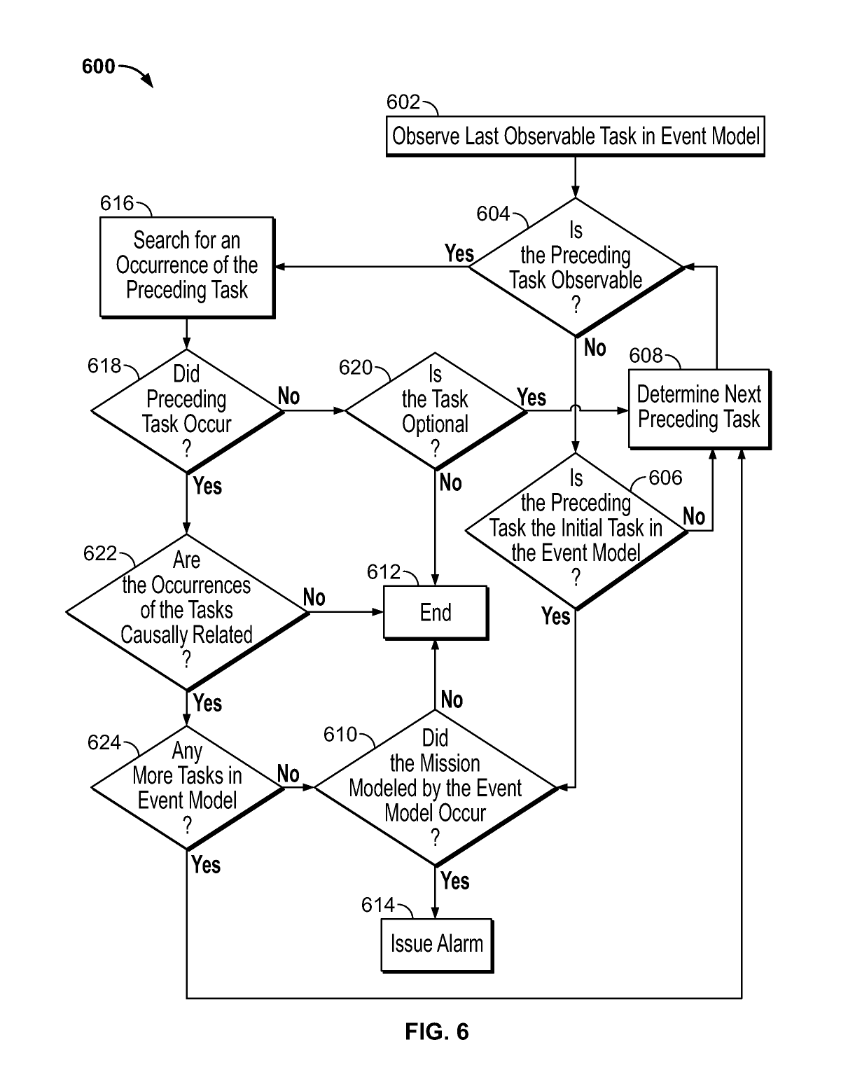

FIG. 6 shows a generalized illustrative process 600 for determining whether a task modeled by an event model has occurred using a traceback search method. For example, the exfiltration mission modeled by event model 400. At step 602 the last observable task in an event model is observed. For example, an observation of the exfiltration event discussed with regard to event model 400 of FIG. 4 by probe 116a as discussed above with regard to step 502 of FIG. 5. After observing the last observable task at step 602, process 600 proceeds to step 604. At step 604 it is determined whether the next preceding task in the event model is observable. For example, with regard to event model 400, there are two possible next preceding tasks (i.e., the tasks before the last observable task); the single system preparation task 408, which is generally not observable (i.e., hidden), and the multi-system preparation task 410, which generally is observable. In a situation where the next preceding task is not observable, process 600 proceeds to step 606. At step 606 it is determined whether the next preceding task is actually the initial task in the event model.

If the next preceding task is the initial task and not observable, no further searching for occurrences of tasks in the event model can take place. As such, process 600 will proceed to step 610 to determine whether the task that the event model represents took place based on the information gathered thus far, which can include information gathered during other tasks not yet discussed. For example, if occurrences of all observable tasks within the event model are found and all found to be causally related, then it is likely that the task that the event model represents took place. In some embodiments, the determination at step 610 may be based on whether a threshold is met. For example, it still may be likely that the task that the event model represents took place even when occurrences of some of the observable tasks are not found and/or not found to be causally related. As such, if a number of occurrences of tasks are found and/or a number of causal relationships are determined, where the number is less than all of the possible occurrences and/or causal relationships, yet still meets or exceeds the threshold, then step 610 will determine that the task that the event model represents likely took place. In some embodiments, the determination at step 610 may be based on how many occurrences are found of a particular task in the event model. For example, if a large number of occurrences of the exfiltration task of event model 400 are found, yet very few or no other occurrences of the other tasks in event model 400 are found, then it still may be determined that the task that the event model represents likely took place.

If it is determined that the task that the event model represents did not occur, process 600 proceeds to step 612 where process 600 ends without any further action. For example, because no determination can be made that a task that the event model represents did occur or because it is determined that the task is did not occur. If it is determined that the task that the event model represents did occur, process 600 proceeds to step 614 where an alarm is issued. Step 614 may be substantially similar to step 526 of FIG. 5 where an alarm is also issued.

If the next preceding task is not the initial task in the event model, then process 600 proceeds from step 606 to step 608 to determine what is the next preceding task in the event model. This may be accomplished by decrementing or incrementing a counter associated with what task in the event model process 600 is currently evaluating. For example, if there are five tasks in an event model, the initial value of the counter will be 5, which represents the last task in the event model. At step 608 this counter would be decremented to 4 to represent the next to last task in the event model. Once the next preceding task is determined, process 600 iterates back to step 604 to determine if the next preceding task is observable (e.g., the second task from the last task in the event model). Process 600 proceeds through step 604, step 606, and step 608 until either an observable task is found in the event model or the initial task is reached.

If the preceding task in the event model is determined to be observable at step 604, then process 600 proceeds to step 616 to search for an occurrence of the preceding task. For example, probes associated with a device that may have carried out the task in question at step 616 may be examined. The searching and probe examination at step 616 may be substantially similar to the examination discussed above with regard to step 506, step 512, and/or step 520. Once the searching and examination is completed at step 616, process 600 proceeds to step 618. At step 618 it is determined whether the preceding task occurred (e.g., was an occurrence of the preceding task found at step 616?). If no occurrence of the preceding task is found at step 618, then process 600 proceeds to step 620. At step 620 it is determined whether the preceding task is optional. For example, it is possible that no occurrence of the task in the event model is found at step 616 and step 618 because the task in question was optional. In such a situation, process 600 proceeds to step 608 to determine what is the next preceding task in the event model as discussed above. However, if the task was not optional and no occurrence was found, process 600 will proceed to step 612 to end as discussed above.

If an occurrence of the preceding task is found at step 618, then process 600 proceeds to step 622 to determine whether the occurrence of the preceding task and occurrences of other tasks in the event model are causally related. The causal relationship determination may be substantially similar to the causal relationship determination made at step 510, step 518, and/or step 524 of FIG. 5. If the occurrences of the tasks are not causally related, then process 600 proceeds to step 612 to end as discussed above. If the occurrences of the tasks are causally related, then process 600 proceeds to step 624 to determine whether there are any further tasks to examine in the event model. If there are no further preceding tasks, then process 600 proceeds to step 610 to determine whether the mission modeled by the event model occurred as discussed above. If there are more preceding tasks in the event model, process 600 proceeds to step 608 to determine what is the next preceding task as discussed above. Process 600 iterates from step 608 to step 624 until process 600 arrives at step 612 to end or step 614 to issue an alarm. Each iteration through process 600 provides more information that is taken into account to make the causal relationship determinations, to narrow down the source(s) of the tasks, and/or make the determination as to whether the mission occurred.

In practice one or more tasks shown in process 600 may be combined with other tasks, performed in any suitable order, performed in parallel (e.g., simultaneously or substantially simultaneously), or removed. Further, additional tasks may be added to process 600 without departing from the scope of the disclosure. Process 600 may be implemented user any suitable combination of hardware (e.g., microprocessor, FPGAs, ASICs, and/or any other suitable circuitry) and/or software in any suitable fashion.

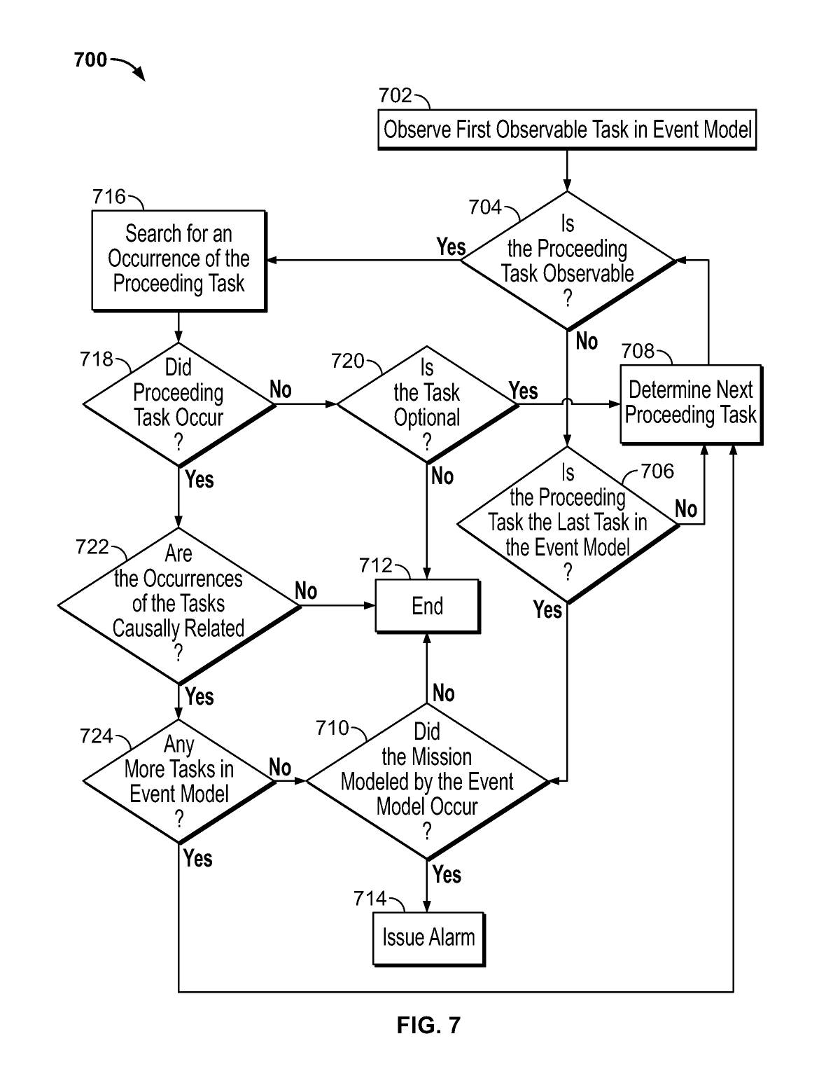

FIG. 7 shows a generalized illustrative process 700 for determining whether a task modeled by an event model has occurred using a trace forward search method. As noted above, with regard to FIG. 4, the determination as to whether a task modeled by an event model has occurred may be done using a trace forward search method as opposed to the traceback search method discussed above. For example, the exfiltration mission modeled by event model 400. Also as noted above, the trace forward search is generally less efficient than the traceback search because the trace forward search can require that many possible partial event model paths are continuously monitored because it is unknown when the next event in an event model will occur; if at all.

At step 702 the first observable task in an event model is observed. For example, an observation of the retrieval of data event discussed with regard to event model 400 of FIG. 4 by one of probes 116 as discussed above with regard to step 520 of FIG. 5. After observing the first observable task at step 702, process 700 proceeds to step 704. At step 704 it is determined whether the next proceeding task in the event model is observable. In a situation where the next proceeding task is not observable, process 700 proceeds to step 706. At step 706 it is determined whether the next proceeding task is actually the last task in the event model. If the next proceeding task is the last task and not observable, no further searching for occurrences of tasks in the event model can take place. As such, process 700 will proceed to step 710 to determine whether the task that the event model represents took place based on the information gathered thus far, which can include information gathered during other tasks not yet discussed. Step 710 is substantially similar to step 610 of FIG. 6. If it is determined that the task that the event model represents did not occur, process 700 proceeds to step 712 where process 700 ends without any further action. For example, because no determination can be made that a task that the event model represents did occur or because it is determined that the task is did not occur. If it is determined that the task that the event model represents did occur, process 700 proceeds to step 714 where an alarm is issued. Step 714 may be substantially similar to step 526 of FIG. 5 where an alarm is also issued.

If the next proceeding task is not the last task in the event model, then process 700 proceeds to step 708 to determine what is the next proceeding task in the event model. This may be accomplished by decrementing or incrementing a counter associated with what task in the event model process 700 is currently evaluating. For example, if there are five tasks in an event model, the initial value of the counter will be 1, which represents the first task in the event model. At step 708 this counter would be incremented to 2 to represent the second task in the event model. Once the next proceeding task is determined, process 700 iterates back to step 704 to determine if the next proceeding task is observable (e.g., the second task in the event model). Process 700 iterates through step 704, step 706, and step 708 until either an observable task is found in the event model or the last task is reached.

If the proceeding task in the event model is determined to be observable at step 704, then process 700 proceeds to step 716 to search for an occurrence of the proceeding task. For example, probes associated with a device that may have carried out the task in question at step 716 may be examined. The searching and probe examination at step 716 may be substantially similar to the examination discussed above with regard to step 506, step 512, and/or step 520. Because the process is searching for events that may not have occurred yet because this is a trace forward search, step 716 may be associated with a timeout threshold. For example, process 700 may search and/or wait for an occurrence of the task for a certain amount of time (e.g., 20 minutes). In some embodiments, process 700 may continue to search for an occurrence of the task periodically for some period of time or indefinitely. For example, process 700 may search for an occurrence of the event for 5 minutes once an hour. If no occurrence is found during the specified time period, process 700 will timeout and determine that the mission modeled by the event model is not occurring.

Once the searching and examination is completed at step 716, process 700 proceeds to step 718. At step 718 it is determined whether the proceeding task occurred (e.g., was an occurrence of the proceeding task found at step 716?). If no occurrence of the proceeding task is found at step 718, then process 700 proceeds to step 720. At step 720 it is determined whether the proceeding task is optional. For example, it is possible that no occurrence of the task in the event model is found at step 716 and step 718 because the task in question was optional. In such a situation, process 700 proceeds to step 708 to determine what is the next proceeding task in the event model as discussed above. However, if the task was not optional and no occurrence was found, process 700 will proceed to step 712 where process 700 ends without any further action as discussed above.

If an occurrence of the proceeding task is found at step 718, then process 700 proceeds to step 722 to determine whether the occurrence of the proceeding task and occurrences of other tasks in the event model are causally related. The causal relationship determination may be substantially similar to the causal relationship determination made at step 510, step 518, and/or step 524 of FIG. 5. If the occurrences of the tasks are not causally related, then process 700 proceeds to step 712 to end as discussed above. If the occurrences of the tasks are causally related, then process 700 proceeds to step 724 to determine whether there are any further tasks to examine in the event model. If there are no further proceeding tasks, then process 700 proceeds to step 710 to determine whether the mission modeled by the event model occurred as discussed above. If there are more proceeding tasks in the event model, process 700 proceeds to step 708 to determine what is the next proceeding task as discussed above. Process 700 iterates from step 708 to step 724 until process 700 arrives at step 712 to end or step 714 to issue an alarm. Each iteration through process 700 provides more information that is taken into account to make the causal relationship determinations, to narrow down the source(s) of the tasks, and/or make the determination as to whether the mission modeled by the event model occurred.

In practice one or more tasks shown in process 700 may be combined with other tasks, performed in any suitable order, performed in parallel (e.g., simultaneously or substantially simultaneously), or removed. Further, additional tasks may be added to process 700 without departing from the scope of the disclosure. Process 700 may be implemented using any suitable combination of hardware (e.g., microprocessor, FPGAs, ASICs, and/or any other suitable circuitry) and/or software in any suitable fashion.

One method of determining whether occurrences of tasks are causally related relies on multi-resolution analysis. In some embodiments, the determination of whether occurrences of tasks are causally related is based on internet multi-resolution analysis (“IMRA”). IMRA is a structured approach to representing, analyzing and visualizing complex measurements from internet-like systems, such as secure network 102 of FIG. 1. IMRA establishes a framework for systematically applying statistical analysis, signal processing or machine learning techniques to provide critical insights into network analysis issues. IMRA is useful when information is too rich, for example, in deep packet inspection over full packet traces. It is also useful when information is too scarce, such as looking at encrypted or wireless traffic. IMRA utilizes various analytical techniques, such as, state-space correlation. State-space correlation examines connection traffic from a causal perspective and is based on the observation that networks attempt to operate efficiently. So, the likelihood that a transmission is response to a prior transmission generally decreases as the elapsed time between them increases (e.g., it is expected that occurrences of related transmissions are temporally located closer than occurrences of unrelated transmissions).

By using state space correlation, a minimum amount of information can be utilized to determine whether or not two events are causally related. For example, just the source of and timing between data transmissions may be sufficient to determine causality when using state space correlation to determine causality. Using a state-space representation of occurrences of transmissions, a conversation probability matrix (CPM) may be generated. The conversation probability matrix corresponds to the probability that a transmission generated at one node is due to a transmission previously generated at another node. The CPM can be represented by the following equation:

$${W}_{ij} = \{ \begin{matrix}{e}^{- λ [ {t}_{i} - {t}_{j} ]} , & if [ {t}_{i} - {t}_{j} ] > 0 \\ x , & otherwise\end{matrix} \qquad Equation 1$$

Here, Wᵢⱼ represents the probability that a transmission generated by node j is due to a transmission previously generated at node i. And, tᵢ and tⱼ represent the time of transmission from node i and node j, respectively. The difference in time between the transmissions generated by node i and node j is represented by [tᵢ−tⱼ]. The calculation of the weight values may be generated based on empirical data. For example, it is possible to count the number of times that event A and event B happen, where the events may be a network transmission or a task in an event model. Then, determine how long it takes for event B to occur after event A occurs. Using this type of empirical calculation, it is possible to determine the probability distributions associated with the events and the probability of a causal relationship between the two events.

FIG. 8 shows illustrative graph 800A and graph 800B regarding the probability that occurrences of events are causally related. For example, the graphs may be based on the CPM described above. Here we assume that event A occurs first in time and then after some period of time after event A occurs, event B then occurs. The x and y axes of both graphs represent time and probability, respectively. With regard to graph 800A, the x-axis begins with event A's arrival time. Line 802A represents the cumulative distribution function for event B, and indicates that the probability of event B's expected arrival goes up as time increases. Line 804A represents the probability of a causal relationship between event A and event B, and indicates that as time goes on from event A's arrival time, the likelihood or the probability that event A and event B are causally related goes down. Based on the intersection of these two lines (e.g., crossover point 806A), it follows that when event B arrives before the crossover point, event A and event B are likely causally related. If event B occurs after the crossover point, event A and event B are unlikely to be causally related. The line modeling for line 802A and 804A can be adjusted according to the particular network that is being analyzed and empirical knowledge regarding communications on that network as well as empirical or experimental knowledge regarding the event models that are being analyzed from which event A and event B may be derived. As an illustrative example, event A may relate to multi-system preparation task 410 of FIG. 4 and event B may relate to exfiltration task 412. Graph 800A as applied to the illustrative example indicates that the greater the length of time between an occurrence of the preparation task 410 and an occurrence of the exfiltration task 412, the less likely the two occurrences are causally related.

Graph 800B illustrates the probability of a causal relationship when more than two events exist, as would generally be the case with most missions that would be represented by the event models discussed above. A causal relationship analysis based on graph 800B would likely not be necessary if event A and event B are found to be independent and/or unrelated. For example, as discussed above with regard to step 622 of FIG. 6, when tasks are found not to be causally related, the traceback search process through an event model may end. However, when two events are found to be causally related, the covert mission traceback search process proceeds to the next preceding task in the event model. When the algorithm proceeds to the next preceding of the event model and the causal relationship is yet again determined all of the preceding tasks. So, as illustrated by graph 800B, event A occurs first, event B occurs second, and event C occurs third. The x-axis begins with event B's arrival time. Line 802B is substantially similar to line 802A, except that line 802B illustrates the cumulative distribution function for the probability of event C occurring with respect to time. As was similarly the case in line 802A, as time increases, the probability of event C occurring also increases. Line 804B illustrates the probability of C being causally related to the causal relationship of A and B. As was similarly the case in line 804A, the probability associated with line 804B also diminishes with time. Specifically, as time elapses, the probability that event C is causally related to the causal relationship of A and B diminishes. Crossover point 806B is similar to crossover point 806A, wherein event C is likely to be causally related to events A and B when event C arrives to the before crossover point 806B. Conversely, when event C occurs after the crossover point, event C is unlikely to be causally related to events A and B.

In some embodiments, the occurrence of a large proportion of tasks in a path of an event model may be sufficient in making a determination that the occurrences are causally related. For example, for some event models it is improbable that a large proportion of tasks in the event model would occur in the correct order over any length of time without a causal relationship between the occurrences. As such, the analysis to determine whether the occurrences of tasks in these event models are causally related does not need to utilize information regarding the time between the occurrences of the tasks, but rather the number of tasks in the event model that have occurred. For example, the confidence level that occurrences of tasks in an event model are causally related will be high when a large number of the tasks in the event model occurred (e.g., 90% of the tasks in the event model) and the occurrences were in the proper order, regardless of the time between the occurrences. As a further example, with reference to event model 300 of FIG. 3, the occurrences of the following events would be found to be likely causally related: an occurrence of task A that precedes an occurrence of task B, which precedes an occurrence of task Ca, which precedes an occurrence of task G. In this example, occurrences of a large number of the visible tasks in path 1 of event model 300 were found to have occurred in the correct order. As such, these occurrences are likely to be causally related, even if the time between some or all of the occurrences is relatively large. In some embodiments, the number of tasks that have occurred may be utilized in determining the confidence level of causality in addition to time differences between the occurrences of events. For example, the confidence level that task A and task B are casually related goes up as the number of event model path occurrences goes up, and may be additionally based on the probabilities described above with regard to graphs 800A and 800B.

The invention may be embodied in other specific forms without departing from the spirit or essential characteristics thereof. For example, the processes disclosed herein for monitoring and mitigating information leaks may be equally applied to networks and/or systems of any suitable size and configured in any suitable manner. As another example, in the embodiments described above, any reference to web traffic is equally applicable to web usage information, web activity, and/or web information and vice versa. The foregoing embodiments are therefore to be considered in all respects illustrative, rather than limiting of the invention.

What is claimed is:

1. A method for detecting a covert mission, the method comprising:
providing an event model that models the covert mission, wherein the event model includes a plurality of ordered tasks;
observing, using a first processor, an occurrence of a first task of the plurality of ordered tasks;
in response to observing the occurrence of the first task, determining, using a second processor, that a second task of the plurality of ordered tasks occurred before the occurrence of the first task, wherein the second task precedes the first task in the event model;
determining if there is a causal relationship between the occurrence of the first task and the occurrence of the second task; and
determining that a covert mission exists based at least in part on the causal relationship.

2. The method of claim 1, further comprising issuing an alarm in response to determining that there is a causal relationship between the occurrence of the first task and the occurrence of the second task.

3. The method of claim 1, wherein the first task is the last observable task in the event model.

4. The method of claim 1, further comprising, in response to determining that there is a causal relationship between the occurrence of the first task and the occurrence of the second task, searching for occurrences of additional tasks of the plurality of ordered tasks that precede the second task in the event model.

5. The method of claim 4, wherein the search is performed sequentially through the ordered plurality of tasks of the event model.

6. The method of claim 5, wherein the sequential search traverses the ordered plurality of tasks of the event model backwards.

7. The method of claim 6, wherein the sequential search is an iterative search that utilizes information about determined occurrences of tasks in the event model to determine whether a preceding task in the event model occurred.

8. The method of claim 1, wherein determining that a casual relationship exists is further based on a causal relationship existing between the occurrence of the first task, the occurrence of second task, and occurrences of other tasks of the plurality of ordered tasks in the event model.

9. The method of claim 1, wherein the determining that the covert mission exists is further based at least in part on how many tasks of the plurality of ordered tasks occurred.

10. The method of claim 1, wherein the determining that the covert mission exists is further based at least in part on whether a threshold is met, wherein the threshold is based at least in part on how many tasks of the plurality of ordered tasks occurred and how many of the occurrences are causally related.

11. The method of claim 1, wherein the determination of a causal relationship is based on an analysis of a difference in time between the occurrence of the first task and the occurrence of the second task.

12. The method of claim 11, wherein a smaller difference in time indicates a greater likelihood that the occurrence of the first task and the occurrence of the second task are causally related.

13. The method of claim 1, wherein the determination of a causal relationship is based on how many tasks of the plurality of ordered tasks occurred.

14. The method of claim 1, wherein the determination of a causal relationship is based on a multi-resolution analysis.

15. The method of claim 1, wherein the determination of a causal relationship is based on a state-space correlation algorithm.

16. The method of claim 1, wherein the determination of a causal relationship is based on a number of times that an ordered task occurs.

17. The method of claim 1, wherein a plurality of network probes is situated in a network to observe the observable tasks in the event model.

18. The method of claim 17, wherein each of the plurality of network probes is situated to observe network communications from at least one of a gateway, router, database, repository, network client, enclave of network clients, and subnets.

19. The method of claim 17, wherein the plurality of network probes tag network traffic by at least one of source address, destination address, time of communication, and type of communication.

20. The method of claim 19, wherein the type of communication includes at least one of internal flow, external flow, data entering, data leaving.

21. A system for detecting a covert mission, the system comprising:
circuitry configured to:
provide an event model that models the covert mission, wherein the event model includes a plurality of ordered tasks;
observe an occurrence of a first task of the plurality of ordered tasks;
in response to observing the occurrence of the first task, determine that a second task of the plurality of ordered tasks occurred before the occurrence of the first task, wherein the second task precedes the first task in the event model;
determine if there is a causal relationship between the occurrence of the first task and the occurrence of the second task; and
determine that a covert mission exists based at least in part on the causal relationship.

22. The system of claim 21, wherein the circuitry is further configured to issue an alarm in response to determining that there is a causal relationship between the occurrence of the first task and the occurrence of the second task.

23. The system of claim 21, wherein the first task is the last observable task in the event model.

24. The system of claim 21, wherein the circuitry is further configured, in response to determining that there is a causal relationship between the occurrence of the first task and the occurrence of the second task, search for occurrences of additional tasks of the plurality of ordered tasks that precede the second task in the event model.

25. The system of claim 24, wherein the search is performed sequentially through the ordered plurality of tasks of the event model.

26. The system of claim 25, wherein the sequential search traverses the ordered plurality of tasks of the event model backwards.

27. The system of claim 26, wherein the sequential search is an iterative search that utilizes information about determined occurrences of tasks in the event model to determine whether a preceding task in the event model occurred.

28. The system of claim 21, wherein determining that a casual relationship exists is further based on a causal relationship existing between the occurrence of the first task, the occurrence of second task, and occurrences of other tasks of the plurality of ordered tasks in the event model.

29. The system of claim 21, wherein the determining that the covert mission exists is further based at least in part on how many tasks of the plurality of ordered tasks occurred.

30. The system of claim 21, wherein the determining that the covert mission exists is further based at least in part on whether a threshold is met, wherein the threshold is based at least in part on how many tasks of the plurality of ordered tasks occurred and how many of the occurrences are causally related.

31. The system of claim 21, wherein the determination of a causal relationship is based on an analysis of a difference in time between the occurrence of the first task and the occurrence of the second task.

32. The system of claim 31, wherein a smaller difference in time indicates a greater likelihood that the occurrence of the first task and the occurrence of the second task are causally related.

33. The system of claim 21, wherein the determination of a causal relationship is based on how many tasks of the plurality of ordered tasks occurred.

34. The system of claim 21, wherein the determination of a causal relationship is based on a multi-resolution analysis.

35. The system of claim 21, wherein the determination of a causal relationship is based on a state-space correlation algorithm.

36. The system of claim 21, wherein the determination of a causal relationship is based on a number of times that an ordered task occurs.

37. The system of claim 21, wherein a plurality of network probes is situated in a network to observe the observable tasks in the event model.

38. The system of claim 37, wherein each of the plurality of network probes is situated to observe network communications from at least one of a gateway, router, database, repository, network client, enclave of network clients, and subnets.

39. The system of claim 37, wherein the plurality of network probes tag network traffic by at least one of source address, destination address, time of communication, and type of communication.

40. The system of claim 39, wherein the type of communication includes at least one of internal flow, external flow, data entering, data leaving.

41. A computer readable medium storing computer executable instructions, which, when executed by a processor, cause the processor to carryout a method for determining whether a third party observer could determine that an organization has an intent with respect to subject matter, the computer readable medium comprising:
providing an event model that models the covert mission, wherein the event model includes a plurality of ordered tasks;
observing, using a first processor, an occurrence of a first task of the plurality of ordered tasks;
in response to observing the occurrence of the first task, determining, using a second processor, that a second task of the plurality of ordered tasks occurred before the occurrence of the first task, wherein the second task precedes the first task in the event model;
determining if there is a causal relationship between the occurrence of the first task and the occurrence of the second task; and
determining that a covert mission exists based at least in part on the causal relationship.
